(19) United States
(12) Patent Application Publication
(10) Pub. No.: US 2013/0027650 A1
(43) Pub. Date: Jan. 31, 2013

(54) LIQUID CRYSTAL DISPLAY DEVICE

(71) Applicants: Yuki Kawashima, Osaka (JP); Keisuke Yoshida, Osaka (JP); Yasutoshi Tasaka, Osaka (JP); Ryohji Yayotani, Osaka (JP); Yoshimizu Moriya, Osaka (JP); Keiichi Ina, Osaka (JP)

(72) Inventors: Yuki Kawashima, Osaka (JP); Keisuke Yoshida, Osaka (JP); Yasutoshi Tasaka, Osaka (JP); Ryohji Yayotani, Osaka (JP); Yoshimizu Moriya, Osaka (JP); Keiichi Ina, Osaka (JP)

(73) Assignee: SHARP KABUSHIKI KAISHA, Osaka (JP)

(21) Appl. No.: 13/639,245

(22) PCT Filed: Mar. 16, 2011
(86) PCT No.: PCT/JP2011/056303

§ 371 Date: Oct. 4, 2012

(30) Foreign Application Priority Data
Apr. 5, 2010 (JP) 2010-087185

(51) Int. Cl. G02F 1/1343

(52) U.S. Cl. 349/143

(57) ABSTRACT

Disclosed is a liquid crystal display device 20 including a display region 11a and a display region 11b. The display region 11a includes pixels 10a provided with, as pixel electrodes, transflective electrodes 15, each including a transmissive electrode 15a that carries out transmissive display, and a reflective electrode 15b that carries out reflective display. The display region 11b includes pixels 10b provided with, as pixel electrodes, transmissive electrodes 16 that carry out transmissive display. The direction in which the long side of the transmissive electrode 15a of the pixel 10a extends is positioned in the same direction in which the long side of the transmissive electrode 16 of the pixel 10b extends. By aligning the long side direction of the transmissive electrode 15a with the long side direction of the transmissive electrode 16, the direction of change in chromaticity in the display region 11a and the direction of change in chromaticity in the display region 11b become the same.

### TECHNICAL FIELD

The present invention relates to a liquid crystal display device, and more particularly, to a liquid crystal display device having a plurality of display regions.

### BACKGROUND ART

In recent years, display devices that use cathode-ray tubes, which were formerly in wide use, have been largely replaced by flat panel display (FPD) devices. FPDs use liquid crystals, light-emitting diodes (LEDs), organic electroluminescence (organic EL), or the like as display elements. Among those, active research and development on display devices that use liquid crystals is taking place due to advantages such as thin profile, light weight, and low power consumption.

As a method for driving liquid crystal display (LCD) devices, a method that uses an active matrix (AM) circuit of thin film transistors (TFTs) is employed. An AM circuit is a switching circuit that controls whether or not each pixel displays data. Since an AM circuit controls each pixel, even if the number of wiring lines in the display device increases, each pixel can be operated effectively. Therefore, liquid crystal display devices that use AM circuits can achieve higher resolution, clearer contrast, and faster response speed.

Among conventional liquid crystal display devices, a transmissive device in which a backlight is disposed on the rear side of the display panel and the backlight is lit in order to conduct a transmissive display was the main type used. However, aside from transmissive liquid crystal display devices, liquid crystal display devices that display images using the reflective method, and liquid crystal display devices that display images using the transflective method are being developed. Reflective display devices reflect external light and use it as a light source for the display by providing a reflective plate inside the device or using a reflective electrode that reflects light radiated from the outside as a pixel electrode. Transflective liquid crystal display devices use an electrode that has a reflective part that reflects light and a transmissive part that transmits light as a pixel electrode, and reflects external light using the reflective part and allows light from the backlight to pass through the transmissive part. Therefore, transflective display devices can conduct display in bright locations using external light as the light source while using a backlight as the light source in dark locations. Generally, reflective liquid crystal display devices or transflective liquid crystal display devices can omit the backlight or reduce the period of time over which the backlight is lit, and thus the amount of power consumed by the display device can be minimized.

Recently, a measure in which one display screen is divided into a plurality of display regions is being considered to reduce the amount of power consumed by the display device. For example, in Patent Document 1, a liquid crystal display device that is provided with a display screen that has a display region that conducts display using the transmissive method and a display region that conducts display using the transflective method is disclosed. According to this, by dividing the display regions according to the type of display data and the like, such as by displaying images in the display region that conducts display using the transmissive method and displaying characters in the display region that conducts display using the transflective method, limitations pertaining to the usage environment can be mitigated, and a balance can be struck between visibility of a displayed image and reducing the consumption of power. In addition, according to that document, by providing an opening in the transmissive display part in the display region that conducts display using the transflective method, the brightness can be increased when conducting transmissive display in the display region. As a result, the difference in brightness between the two display regions can be reduced, and images can be displayed with a natural appearance.

### RELATED ART DOCUMENTS

### Patent Documents

Patent Document 1: Japanese Patent Application Laid-Open Publication, “Japanese Patent Application Laid-Open Publication No. 2006-189499 (Published on Jul. 20, 2006)”

Patent Document 2: Japanese Patent Application Laid-Open Publication, “Japanese Patent Application Laid-Open Publication No. 2008-225495 (Published on Sep. 25, 2008)”

### SUMMARY OF THE INVENTION

### Problems to be Solved by the Invention

In a conventional vertical alignment mode liquid crystal display device, there is a problem that when viewing a display screen from a diagonal direction, the displayed image takes on a white tinge compared to when the display screen is viewed from the frontal direction. This is because the size of the retardation generated in the liquid crystal layer varies. The retardation of the liquid crystal layer will be described in detail with reference to FIG. 7, below. FIG. 7 is a drawing that shows transmittance characteristics in a conventional liquid crystal display device. In this drawing, the horizontal axis represents the voltage (V) applied to the liquid crystal layer and the vertical axis represents the transmittance (%) of light. The drawing shows the transmittance characteristics when the display screen is viewed from the frontal direction and the transmittance characteristics when the display screen is viewed from a position at an angle of elevation of 60°.

Generally, in liquid crystal display devices, liquid crystal molecules are controlled so as to be oriented in a plurality of directions by providing alignment control structures or the like in the liquid crystal layer. Specifically, the orientation direction of the liquid crystal molecules changes at the boundary of the alignment control structures. As a result, as shown in FIG. 7, a difference appears between the transmittance characteristics when the display screen is viewed from the frontal direction (the ⋄ symbol in the drawing), and the transmittance characteristics when the display screen is viewed from a diagonal direction (the Δ symbol in the drawing). Specifically, the transmittance characteristics when the display screen is viewed from the diagonal direction have a gradation region in which the transmittance is higher compared to the transmittance characteristics when the display screen is viewed from the frontal direction, and a gradation region in which the transmittance is lower. As a result, in the region where the transmittance when the display screen is viewed from the diagonal direction is greater than that when the display screen is viewed from the frontal direction, displayed images that are at a dark halftone take on a white tinge.

Additionally, in conventional liquid crystal display devices, a difference also appears between the chromaticity characteristics when the display screen is viewed from the frontal direction and the chromaticity characteristics when the display screen is viewed from a diagonal direction. The chromaticity also varies depending on the size of the retardation generated in the liquid crystal layer, which results in the chromaticity changing depending on the viewing angle. As a result, there is a problem that the chromaticity in the diagonal view differs from the chromaticity in the frontal view.

In order to eliminate the above-mentioned problems, Patent Document 2 discloses a liquid crystal display device that is configured so as to provide a low effective voltage region in one part thereof in which an effective voltage lower than a voltage applied between substrates is applied to liquid crystals, and such that the threshold voltages between the low effective voltage region and other regions differ. According to this, the transmittance characteristics between regions with different threshold voltages are averaged, thus reducing the difference in transmittance between the frontal view and the diagonal view. Therefore, excellent gradation visual characteristics in which there is little difference in chromaticity of the displayed image between the frontal view and the diagonal view can be attained.

Factors for determining the size of the retardation generated in the liquid crystal layer include layouts of alignment control structures provided in the liquid crystal layer, bus lines, or pixel electrodes and the like. Therefore, depending on the structure of the pixels, retardation of liquid crystal molecules can occur within each pixel. In a case in which the display screen is divided into a plurality of display regions as in the liquid crystal display device disclosed in Patent Document 1, the form of the pixel electrodes and the like differs depending on the display region; therefore, the pixel structure differs for each display region. As a result, the visibility state of the display screen of such a liquid crystal display device is as shown in FIG. 8. In the drawing, the difference in hues is shown with different shading.

FIG. 8(a) is a drawing that schematically shows a chromaticity state when a liquid crystal display device 40 is placed vertically and viewed from a diagonal direction. As shown in the drawing, when viewing the liquid crystal display device 40 from the diagonal direction, a display region 21a and a display region 21b have different hues, and a change in chromaticity of the display region 21a is more noticeable. FIG. 8(b) is a drawing that schematically shows a chromaticity state when the liquid crystal display device 40 is placed horizontally and viewed from a diagonal direction. As shown in the present drawing, when viewing the liquid crystal display device 40 from the diagonal direction, the display region 21a and the display region 21b have different hues, and a change in chromaticity of the display region 21b is more noticeable.

As described above, the chromaticity of each display region differs depending on the viewing angle due to the direction of the change in chromaticity differing for each display region, which results in a decreased display quality in the liquid crystal display device. With the technique disclosed in Patent Document 2, it is possible to improve the change in chromaticity in one display region, but this technique is unable to deal with a situation in which each region among a plurality of display regions has changes in chromaticity.

The present invention takes into account the above-mentioned problems and an objective thereof is to provide a vertical alignment liquid crystal display device having a plurality of display regions that can mitigate the decrease in display quality due to differences in chromaticity change across display regions.

### Means for Solving the Problems

In order to solve the above-mentioned problems, a liquid crystal display device according to the present invention is a vertical alignment type having a plurality of pixels, including: a pixel electrode, an opposite electrode facing the pixel electrode, and a liquid crystal layer interposed between the pixel electrode and the opposite electrode, for each pixel; a first display region including a plurality of first pixels as the plurality of pixels; and a second display region including a plurality of second pixels differing from the plurality of first pixels as the plurality of pixels, wherein a part of the pixel electrode in each first pixel is a rectangular transmissive electrode that transmits light, wherein at least a part of the pixel electrode in each second pixel is a rectangular transmissive electrode that transmits light, and wherein an extension direction of a long side of the transmissive electrode of the first pixel and an extension direction of the long side of the transmissive electrode of the second pixel are the same.

According to the above configuration, the first pixel has a pixel electrode in which a part thereof is a transmissive electrode that conducts transmissive display, and the second pixel has a pixel electrode in which at least a part thereof is a transmissive electrode that conducts transmissive display. In addition, the transmissive electrode of the first pixel and the transmissive electrode of the second pixel are disposed such that the respective long side extension directions coincide with each other.

Generally, in a liquid crystal display device provided with a plurality of display regions, the retardation of the liquid crystals in each display region differs depending on the viewing direction. One of the reasons for this is that the respective display regions have different pixel structures such as the pixel electrode shapes. As a result, in a plurality of display regions that have different pixel structures, the size of the retardation of the liquid crystals differs for each display region. Thus, the chromaticity changes for each display region, which has a negative effect on the display quality of the liquid crystal display device.

In the present invention, by aligning together the long side direction of the transmissive electrode of the first pixel and the long side direction of the transmissive electrode of the second pixel, the distribution of the liquid crystal retardation in the first display region and the distribution of the liquid crystal retardation in the second display region of each viewing direction is made to be the same. As a result, the direction of the change in chromaticity of the first display region and the direction of the change in chromaticity of the second display region are the same, and even when viewing the display screen from the diagonal direction, it is possible to prevent a hue of one of the first display region and the second display region from standing out. Thus, the variations in chromaticity are not visible in the display screen as a whole, thus preventing a decrease in display quality. Therefore, a liquid crystal display device having an excellent display quality can be provided.

The other objects, features, and effects of the present invention will be readily understood from the descriptions that follow. The advantages of the present invention will become apparent by the following descriptions with reference to the appended drawings.

### Effects of the Invention

In the present invention, by aligning together the long side direction of the transmissive electrode of the first pixel and the long side direction of the transmissive electrode of the second pixel, the distribution of liquid crystal retardation in the first display region and the distribution of liquid crystal retardation in the second display region are made to be the same. As a result, the direction of the change in chromaticity of the first display region and the direction of the change in chromaticity of the second display region coincide with each other, which means that even when viewing the display screen from the diagonal direction, the hue of neither the first display region nor the second display region becomes more prominent than the other. Thus, the variations in chromaticity of the display screen as a whole become less noticeable, which can prevent a decrease in display quality. Thus, a liquid crystal display device having excellent display quality can be provided.

### BRIEF DESCRIPTION OF THE DRAWINGS

FIG. 1 is a drawing that schematically shows the shape of pixel electrodes of each display region according to one embodiment of the present invention.

FIG. 2 is an equivalent circuit diagram that shows an electric configuration of an entire liquid crystal display device according to one embodiment of the present invention.

FIG. 3 is a drawing that schematically shows the shape of pixel electrodes of each display region according to one embodiment of the present invention.

FIG. 4(a) is a chromaticity diagram that shows chromaticity characteristics when a display surface of a display region is viewed from a position at an angle of elevation of 60°,

FIG. 4(b) is a chromaticity diagram that shows chromaticity characteristics when a display surface of a display region is viewed from a position at an angle of elevation of 60°, and

FIG. 4(c) is a chromaticity diagram that shows chromaticity characteristics when a display surface of a display region is viewed from a position at an angle of elevation of 60°.

FIG. 5(a) is a drawing that schematically shows the shape of pixel electrodes according to one embodiment of the present invention, and FIG. 5(b) is a drawing that schematically shows the shape of pixel electrodes according to one embodiment of the present invention.

FIG. 6(a) is a drawing that schematically shows the shape of pixel electrodes according to one embodiment of the present invention, and FIG. 6(b) is a drawing that schematically shows the shape of pixel electrodes according to one embodiment of the present invention.

FIG. 7 is a drawing that shows transmittance characteristics in a conventional liquid crystal display device.

FIG. 8(a) is a drawing that schematically shows a chromaticity state when a conventional liquid crystal display device is placed vertically and viewed from a diagonal direction, and FIG. 8(b) is a drawing that schematically shows a state when the conventional liquid crystal display device is placed horizontally and viewed from a diagonal direction.

### DETAILED DESCRIPTION OF EMBODIMENTS

### Overview of Liquid Crystal Display Device 20

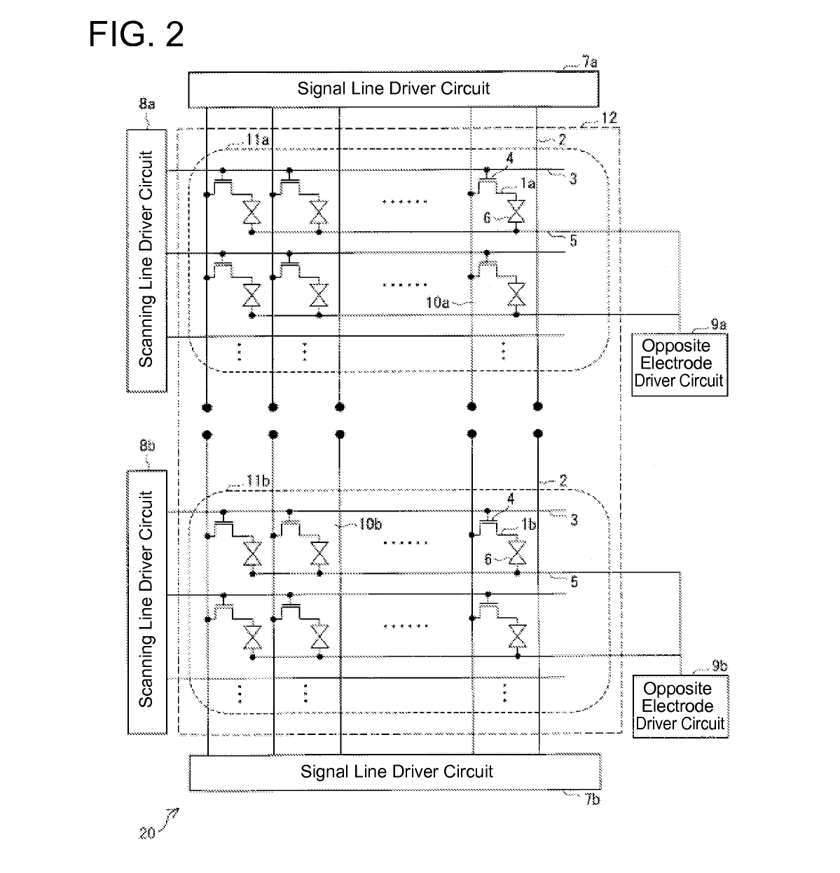

One embodiment of the present invention will be described with reference to the drawings. First, a schematic of a liquid crystal display (LCD) device according to the present embodiment will be explained with reference to FIG. 2. FIG. 2 is an equivalent circuit diagram that shows an electric configuration of the entire liquid crystal display device 20.

The liquid crystal display device according to the present embodiment is a vertical alignment (VA) liquid crystal display device in which liquid crystal molecules having negative dielectric anisotropy (ε<0) are vertically aligned to substrates. As shown in FIG. 2, the liquid crystal display device 20 is provided with a liquid crystal panel 12, signal line driver circuits 7a and 7b, and scanning line driver circuits 8a and 8b. The liquid crystal panel 12 has a display region 11a (first display region) and a display region 11b (second display region), which will be described below. In the display region 11a, display is conducted through the transflective method, and in the display region 11b, display is conducted through the transmissive method or the transflective method.

Specifically, the liquid crystal panel 12 is constituted of a TFT substrate (not shown in drawings), an opposite substrate (not shown in drawings), and a liquid crystal layer sandwiched therebetween, and has a plurality of pixels 10a and 10b, which are arranged in a matrix. The liquid crystal panel 12 is provided with pixel electrodes 1a and 1b, signal lines 2, scanning lines 3, and thin film transistors (TFTs) 4 on the TFT substrate, while being provided with an opposite electrode 5 and opposite electrode driver circuits 9a and 9b on the opposite substrate. In the drawing, reference character 6 shows a liquid crystal cell, and the liquid crystal cell 6 is used electrically as a capacitance element.

In the display region 11a, the signal lines 2 are formed such that there is one signal line per column and the signal lines are parallel to each other in the column direction (vertical direction). The scanning lines 3 are formed such that there is one scanning line per row and the scanning lines are parallel to each other in the row direction (horizontal direction). A plurality of signal lines 2 and a plurality of scanning lines 3 are disposed so as to intersect with each other, and a pixel 10a (first pixel) is formed at each intersection thereof. In other words, the region surrounded by two adjacent signal lines 2 and two adjacent scanning lines 3 forms one pixel 10a. A pixel electrode 1a and a TFT 4 are respectively formed for each pixel 10a. The source electrode of the TFT 4 is electrically connected to the signal line 2 and the gate electrode is electrically connected to the scanning line 3. The drain electrode is electrically connected to the pixel electrode 1a. The pixel electrode 1a forms a liquid crystal capacitance between the pixel electrode 1a and the opposite electrode 5 via the liquid crystal cell 6.

With this configuration, the gate of the TFT 4 is turned on due to a scanning signal supplied from the scanning line driver circuit 8a to the scanning line 3, and the data signal supplied from the signal line driver circuit 7a to the signal line 2 is written in to the pixel electrode 1a, and the pixel electrode 1a is set to a potential corresponding to the data signal. The opposite electrode 5 is set to a prescribed potential through the opposite electrode driver circuit 9a, and the liquid crystal cell 6, which is interposed between the pixel electrode 1a and the opposite electrode 5, attains gradation display corresponding to the difference in potential between the two electrodes.

In the display region 11b, a plurality of signal lines 2 and a plurality of scanning lines 3 are disposed so as to intersect with each other, and a pixel 10b (second pixel) is formed at each intersection thereof. In each pixel 10b, a pixel electrode 1b and a TFT 4 are respectively formed. The source electrode of the TFT 4 is electrically connected to the signal line 2 and the gate electrode is electrically connected to the scanning line 3. The drain electrode is electrically connected to the pixel electrode 1b. The pixel electrode 1b forms a liquid crystal capacitance between the pixel electrode 1b and the opposite electrode 5 via the liquid crystal cell 6.

With this configuration, the gate of the TFT 4 is turned on due to a scanning signal supplied from the scanning line driver circuit 8b to the scanning line 3, and the data signal supplied from the signal line driver circuit 7b to the signal line 2 is written in to the pixel electrode 1b, and the pixel electrode 1b is set to a potential corresponding to the data signal. The opposite electrode 5 is set to a prescribed potential through the opposite electrode driver circuit 9b, and the liquid crystal cell 6, which is interposed between the pixel electrode 1b and the opposite electrode 5, attains gradation display corresponding to the difference in potential between the two electrodes.

As described above, the signal lines 2 in the display region 11a are controlled by the signal line driver circuit 7a, and the scanning lines 3 are controlled by the scanning line driver circuit 8a. Therefore, the display region 11a is driven by the signal line driver circuit 7a and the scanning line driver circuit 8a. In the display region 11b, the signal lines 2 are controlled by the signal line driver circuit 7b and the scanning lines 3 are controlled by the scanning line driver circuit 8b. Therefore, the display region 11b is driven by the signal line driver circuit 7b and the scanning line driver circuit 8b. In this way, the display region 11a and the display region 11b according to the present embodiment can each be independently driven.

There are no special limitations on the configuration of the display region 11a and the display region 11b, and it is possible to have a liquid crystal display device 20a in which a memory circuit that stores image data is provided for each pixel 10a in the display region 11a, for example. By storing image data in the memory circuit, a continuous supply of image data from the outside becomes unnecessary, which makes it possible to display images without consuming a lot of power In this case, various wiring lines such as intra-pixel circuit driver wiring lines are provided together with the scanning lines 3. Here, the specifics of such a configuration will not be discussed.

### Configuration of Display Region 11a and Display Region 11b

As described above, the liquid crystal display device 20 has the display region 11a and the display region 11b. The display region 11a conducts display through the transflective method while the display region 11b conducts display through the transmissive method or the transflective method. The display region 11a conducts display using the transflective method, and therefore, for the pixel electrode 1a, a transflective electrode that has a part constituted of an electrode that transmits light from the backlight and a part constituted of an electrode that reflects external light is used. If the display region 11b conducts display using the transmissive method, a transmissive electrode that transmits light from the backlight is used for the pixel electrode 1b. If the display region 11b conducts display using the transflective method, then for the pixel electrode 1b, a transflective electrode that has a part constituted of an electrode that transmits light from the backlight and a part constituted of an electrode that reflects external light is used.

In the case of a configuration that has a plurality of display regions such as that of the present embodiment, the direction of the change in chromaticity would differ for each display region. As a result, the chromaticity of each display region would differ depending on the viewing angle, which decreases the display quality of the liquid crystal display device. Therefore, in the present embodiment, the shape of the pixel electrode 1a of the display region 11a or the pixel electrode 1b of the display region 11b is changed so that the direction of the change in chromaticity in the display region 11a coincides with the direction of the change in chromaticity in the display region 11b. As a result, a decrease in display quality of the liquid crystal display device 20 can be prevented.

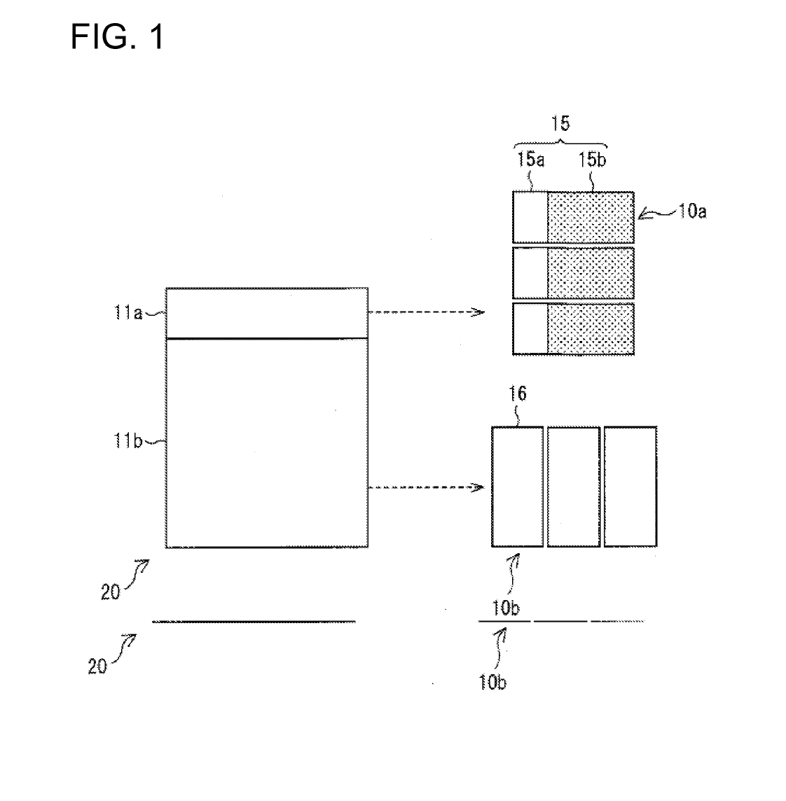

Specifically, an example in which the display region 11a uses the transflective method and the display region 11b uses the transmissive method will be described. In this case, the shapes of the pixel electrodes for each of the display regions 11a and 11b in the liquid crystal display device 20 are shown schematically in FIG. 1. As shown in FIG. 1, in the display region 11a, a transflective electrode 15 that has a transmissive electrode 15a, which is constituted of an electrode that transmits light from the backlight, and a reflective electrode 15b, which is constituted of an electrode that reflects external light, is used as the pixel electrode 1a. In the display region 11b, a transmissive electrode 16 that transmits light from the backlight is used for the pixel electrode 1b.

In the present embodiment, if there are a plurality of display regions and all display regions are each provided with electrodes of the same display method (in other words, if one of the display regions has transmissive electrodes 16 and the other has transflective electrodes 15 (transmissive electrodes 15a), or if all display regions have transflective electrodes 15 (transmissive electrodes 15a)), the shapes of the electrodes thereof are changed. In FIG. 1, for example, the transmissive electrodes 15a of the transflective electrodes 15 of the display region 11a, and the transmissive electrodes 16 of the display region 11b are used for the same transmissive method. The shape of the transflective electrodes 15 of the display region 11a or the transmissive electrodes 16 of the display region 11b is changed so as to make the long side extension direction (hereinafter, referred to as the long side direction) of the transmissive electrodes 15a and the long side direction of the transmissive electrodes 16 the same. In FIG. 1, the long side direction of the transmissive electrodes 15a and the long side direction of the transmissive electrodes 16 are the same.

According to the above-mentioned configuration, the direction of the change in chromaticity of the display region 11a and the direction of the change in chromaticity of the display region 11b are made to be the same. The detailed mechanism thereof will be described below.

### Adjusting Direction of Change in Chromaticity

Generally, in a liquid crystal display device, the transmittance characteristics thereof depend on the size of the retardation generated in the liquid crystal layer. The chromaticity characteristics of the liquid crystal display device also depend on the size of the retardation generated in the liquid crystal layer. Because the size of the retardation generated in the liquid crystal layer varies within the liquid crystal display device, there is a gap between the transmittance characteristics from the frontal direction and the transmittance characteristics from the diagonal direction, and there is also a gap between the chromaticity characteristics from the frontal direction and the chromaticity characteristics from the diagonal direction. As a result, the chromaticity varies depending on the viewing angle, which has a negative effect on the display quality of the liquid crystal display device.

A factor that determines the size of the retardation of the liquid crystal layer is the shape of the pixel electrodes. Depending on the shape of the pixel electrodes, the size of the retardation of the liquid crystal layer changes. In other words, in the display region 11a and the display region 11b where the shapes of the pixel electrodes 1a and 1b differ, the respective directions of the change in chromaticity differ. As a result, the chromaticity between the display regions 11a and 11b differs depending on the viewing angle, which results in a decrease in display quality of the liquid crystal display device 20.

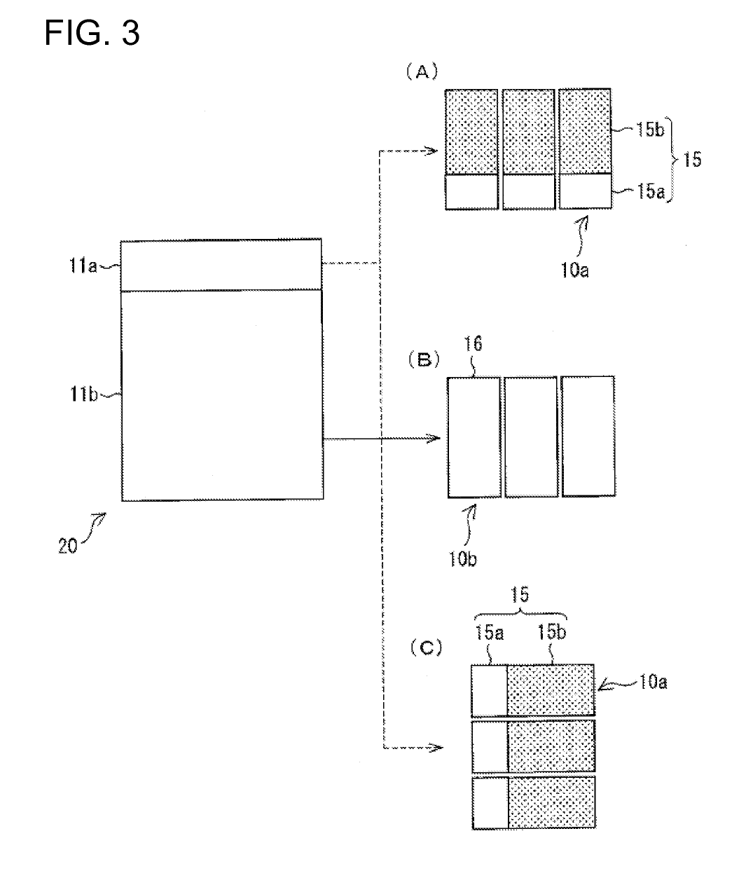

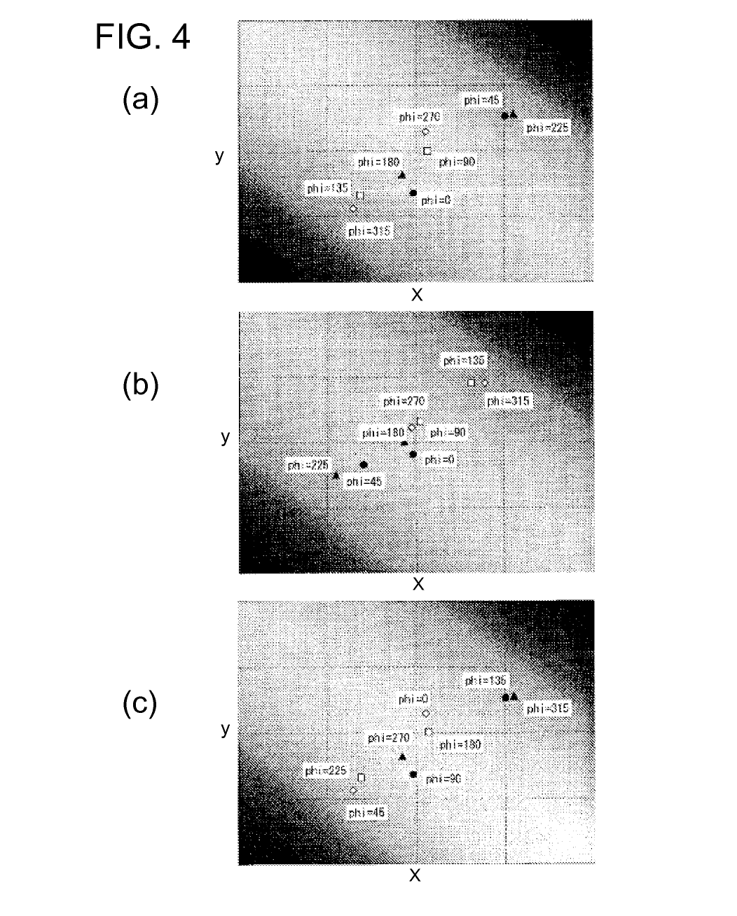

FIG. 3 schematically shows the pixel electrode shapes of the display regions 11a and 11b. As shown in FIG. 3, normally, in the pixels 10a of the display region 11a, the transflective electrodes 15 are arranged as in (A) while in the pixels 10b of the display region 11b, the transmissive electrodes 16 are arranged as in (B). The chromaticity characteristics of when the transflective electrodes 15 are arranged as in (A) are shown in FIG. 4(a). FIG. 4(a) is a chromaticity diagram that shows chromaticity characteristics when a display surface of the display region 11a is viewed from a position at an angle of elevation of 60°. As shown in the diagram, when the display screen is viewed from positions at azimuths (phi) of 45° and 225°, the chromaticity of the display screen changes towards yellow. On the other hand, if the display screen is viewed from positions at azimuths of 135° and 315°, the chromaticity of the display screen changes towards blue.

The chromaticity characteristics when the transmissive electrodes 16 are arranged as in (B) of FIG. 3 are shown in FIG. 4(b). FIG. 4(b) is a chromaticity diagram that shows chromaticity characteristics when a display surface of the display region 11b is viewed from a position at an angle of elevation of 60°. As shown in the diagram, when the display screen is viewed from positions at azimuths (phi) of 45° and 225°, the chromaticity of the display screen changes towards blue. On the other hand, if the display screen is viewed from positions at azimuths of 135° and 315°, the chromaticity of the display screen changes towards yellow.

As described above, the display region 11a where the transflective electrodes 15 are arranged as in (A) of FIG. 3 and the display region 11b where the transmissive electrodes 16 are arranged as in (B) have different directions of change in chromaticity when viewed from positions at azimuths of 45° and 225°, and change in opposite directions to each other. Similarly, when viewed from positions at azimuths of 135° and 315°, the directions of change in chromaticity are different, and change in opposite directions to each other. In other words, depending on the viewing angle, the directions of the change in chromaticity of the display region 11a and the display region 11b differ from each other, and therefore, the hue of one of the display region 11a and the display region 11b becomes more prominent than the other. This is because the distribution of retardation of the liquid crystals in the display region 11a and the distribution of retardation of the liquid crystals in the display region 11b differ when viewed from a position at an angle of elevation of 60°. As a result, the display quality of the entire display screen decreases.

In the present embodiment, transflective electrodes 15 in the pixels 10a of the display region 11a are arranged as in (C) of FIG. 3. Specifically, the long side direction of the transmissive electrodes 16, which are aligned as in (B), is arranged to be the same as the long side direction of the transmissive electrodes 15a of the pixel electrodes 1a. The chromaticity characteristics when the transflective electrodes 15 are arranged as in (C) are shown in FIG. 4(c). FIG. 4(c) is a chromaticity diagram that shows chromaticity characteristics when a display surface of the display region 11a is viewed from a position at an angle of elevation of 60°. As shown in the diagram, when the display screen is viewed from positions at azimuths of 45° and 225°, the chromaticity of the display screen changes towards blue. On the other hand, when viewed from positions at azimuths of 135° and 315°, the chromaticity of the display screen changes towards yellow.

Thus, the display region 11a in which the transflective electrodes 15 are arranged as in (C) and the display region 11b in which the transmissive electrodes 16 are arranged as in (B) have the same direction of chromaticity change when viewed from positions at azimuths of 45° and 225°. Similarly, the directions of change in chromaticity when viewed from positions at azimuths of 135° and 315° are the same. In other words, even if the display screen is viewed from the diagonal directions, the directions of change in chromaticity of the display region 11a and the display region 11b are the same; therefore, the hue of neither the display region 11a nor the display region 11b becomes more prominent than the other. This is because, by making the long side direction of the transmissive electrodes 16 and the long side direction of the transmissive electrodes 15a the same, the distribution of retardation of the liquid crystals in the display region 11a and the distribution of retardation of the liquid crystals in the display region 11b become the same. As a result, the change in chromaticity becomes less noticeable over the entire display screen, and a decrease in display quality can be prevented. Therefore, it is possible to provide a liquid crystal display device 20 that has excellent display quality.

### Example of Shape of Pixel Electrodes 1a

As described above, in the present embodiment, if electrodes of the same display method are provided for the pixel electrodes 1a and the pixel electrodes 1b (in other words, if one has transmissive electrodes 16 and the other has transflective electrodes 15 (transmissive electrodes 15a), or if both have transflective electrodes 15 (transmissive electrodes 15a)), then the shapes of the electrodes are adjusted. Specifically, the long side directions of the electrode portions that use the same method are made to be the same.

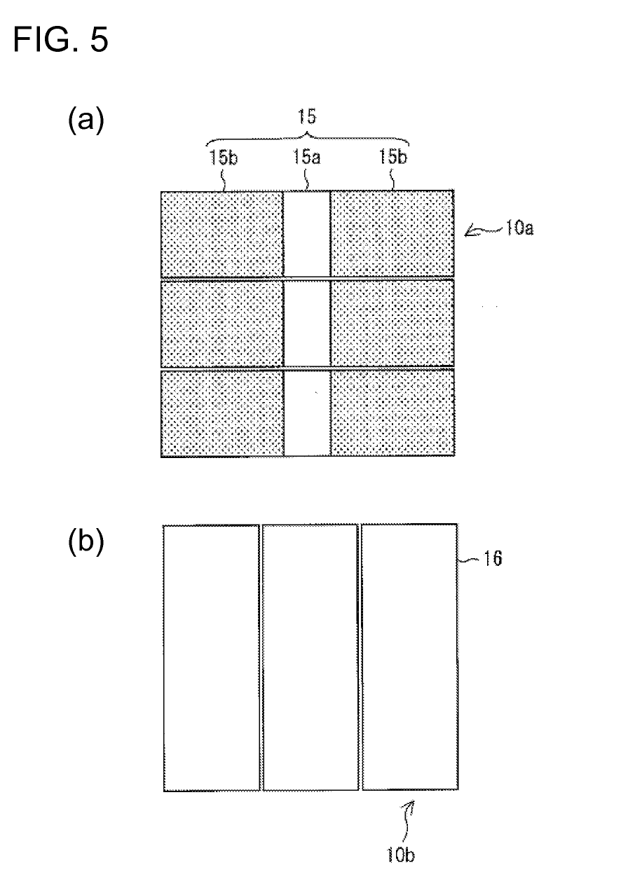

An example of a configuration in which the transflective method is used in the display region 11a and the transflective electrode 15 is made of a transmissive electrode 15a and a reflective electrode 15b was shown above, but the configuration is not necessarily limited to this. For example, it is possible to have a pixel electrode 1a made of a transflective electrode 15 in which a transmissive electrode 15a is formed between two reflective electrodes 15b in the display region 11a that uses the transflective method. In this case, an example of the shapes of the pixel electrodes 1a and 1b are shown in FIG. 5. FIG. 5(a) schematically shows the shape of a pixel electrode 1b (transflective electrode 15) in the pixel 10a of the display region 11a. FIG. 5(b) schematically shows the shape of a pixel electrode 1b (transmissive electrode 16) in the pixel 10b of the display region 11b.

As shown in FIG. 5(b), the long side direction of the transmissive electrode 16 of the pixel 10b extends in the up and down direction in the drawing. Since the transmissive electrode 15a of the transflective electrode 15 of the pixel 10a uses the same transmissive method as the transmissive electrode 16 of the pixel 10b, the transmissive electrode 15a is disposed such that the long side direction of the transmissive electrode 15a coincides with the long side direction of the transmissive electrode 16 of the pixel 10b, or in other words, the up and down direction in the drawing, as shown in FIG. 5(a). As a result, the long side directions of the transmissive electrode 15a and the transmissive electrode 16, which use the same transmissive method, coincide with each other. This means that the direction of chromaticity change is the same between the display region 11a and the display region 11b. As a result, the hue of neither the display region 11a nor the display region 11b becomes more prominent than the other, thus preventing a decrease in display quality.

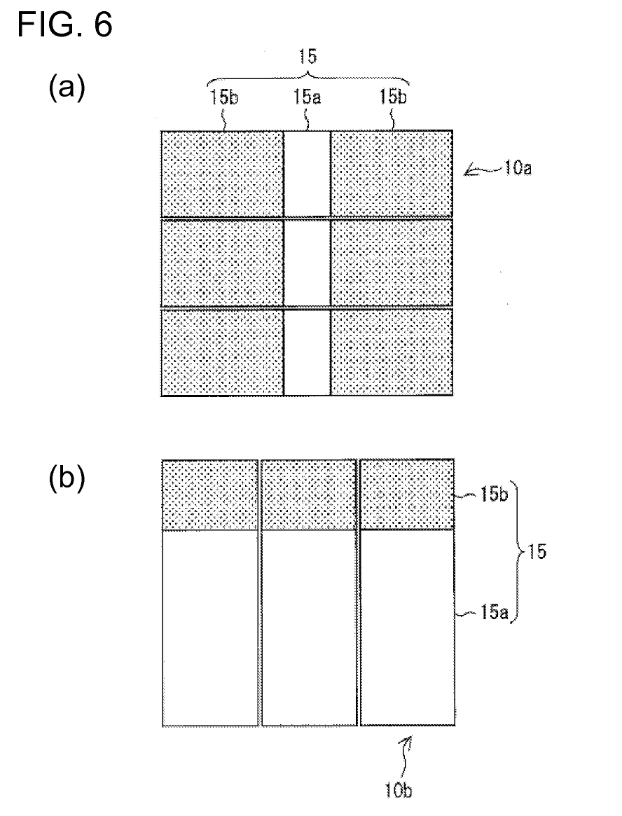

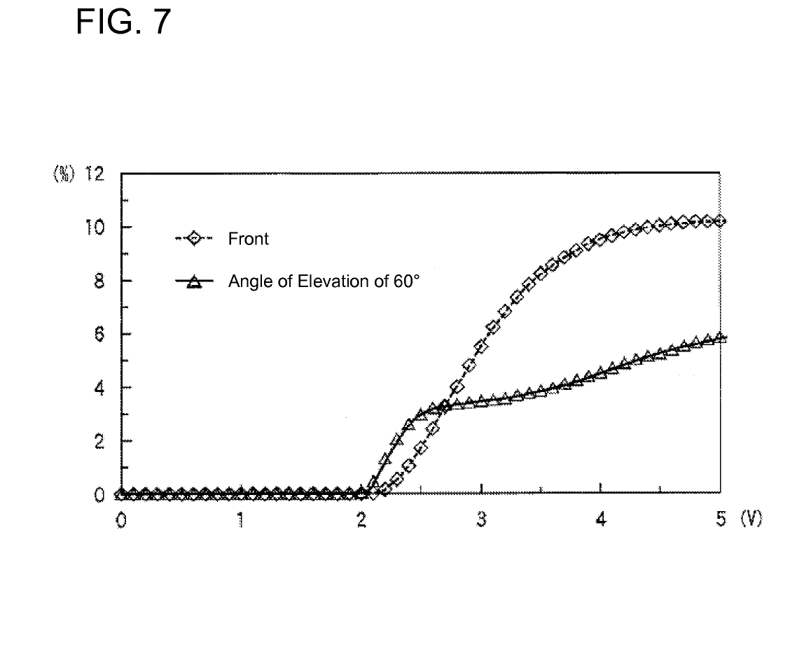

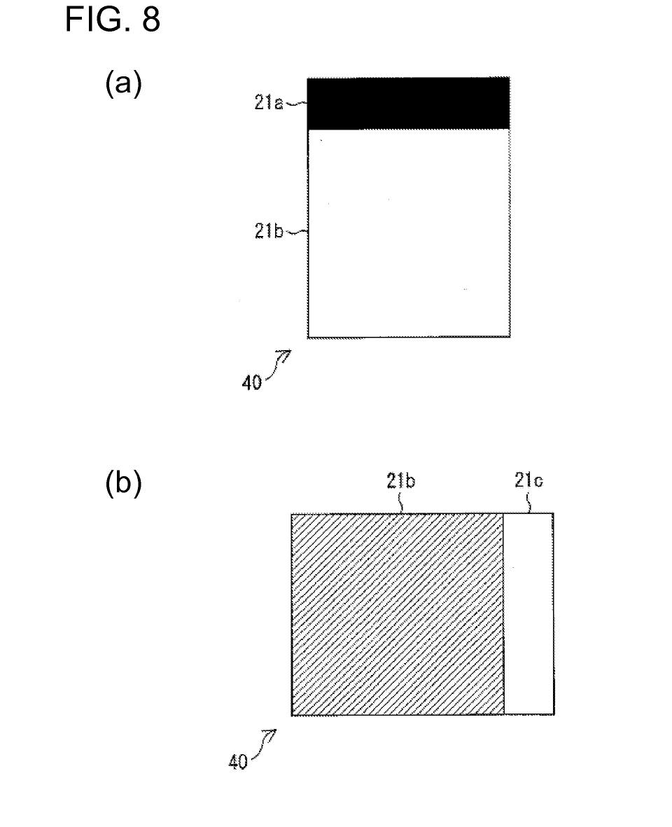

Also, according to the above, a case in which the transflective method is used in the display region 11a and the transmissive method is used in the display region 11b was shown, but the configuration is not necessarily limited to this. It is possible to have the display region 11a and the display region 11b both use the transflective method, for example. Examples of the shapes of the pixel electrodes 1a and 1b in such a case are shown in FIG. 6. FIG. 6(a) is a drawing that schematically shows the shape of the pixel electrode 1a (transflective electrode 15) in the pixel 10a in the display region 11a. FIG. 6(b) is a drawing that schematically shows the shape of the pixel electrode 1b (transflective electrode 15) in the pixel 10b in the display region 11b.

As shown in FIG. 6(b), the long side direction of the transmissive electrode 15a of the transflective electrode 15 in the pixel 10b extends in the up and down direction in the drawing. Here, the transmissive electrode 15a of the pixel 10a uses the same transmissive method as the transmissive electrode 15a in the pixel 10b, and thus, as shown in FIG. 6(a), the long side direction of the transmissive electrode 15a of the pixel 10a is disposed so as to coincide with the long side direction of the transmissive electrode 15a of the pixel 10b; in other words, so as to extend in the up and down direction of the drawing. As a result, the long side directions of the transmissive electrode 15a of the pixel 10a and the transmissive electrode 15a of the pixel 10b coincide with each other, and therefore, the directions of chromaticity change of the display region 11a and the display region 11b are the same. Thus, the hue of neither the display region 11a nor the display region 11b becomes more prominent than the other, which prevents a decrease in display quality.

The direction that the long side of the transmissive electrode 15a of the pixel 10a and the long side of the transmissive electrode 15a of the pixel 10b extend is not particularly limited. In other words, having the long side directions of the transmissive electrode 15a of the pixel 10a and the electrode 15a of the pixel 10b extend in the left and right direction in FIGS. 6(a) and 6(b) does not present any problems. As long as the long side directions of the transmissive electrode 15a of the pixel 10a and the transmissive electrode 15a of the pixel 10b match, then the effect of the present invention can be attained whether the long side direction of both transmissive pixels 15a extends in the up and down direction or the left and right direction of the drawings.

The description above shows a case in which the liquid crystal display device 20 has two display regions 11a and 11b, but the present embodiment is not limited to this. A configuration that has three or more display regions can also be used, for example.

In the above embodiments, the pixels 10a and 10b are shown as a set of three pixels arranged side by side, with the assumption that each of the pixels 10a and 10b is constituted of three subpixels (red (R) pixel, green (G) pixel, and blue (B) pixel). However, the present embodiment is not limited to this.

In the embodiments, a case in which the pixel electrode 1a and the pixel electrode 1b have electrode portions for the same display method (in other words, one has a transmissive electrode 16 and the other has a transflective electrode 15 (transmissive electrode 15a), or both have transflective electrodes (transmissive electrode 15a)) was described, but it goes without saying that the electrode portions are assumed to be rectangular. In other words, a case in which the transmissive electrode 16 or the transmissive electrode 15a is square shaped is not included.

The present invention is not limited to the embodiments described above, and various modifications can be made without departing from the scope of the claims. In other words, embodiments attained by combining techniques that are appropriately modified within the scope of the claims also fall within the scope of the claims of the present invention.

### Summary of Embodiments

As stated above, the liquid crystal display device according to the present invention is one in which a part of the pixel electrode in each second pixel is a transmissive electrode.

Also, the liquid crystal display device according to the present invention is one in which a region aside from the transmissive electrode in the pixel electrode in each first pixel is a reflective electrode that reflects light, and in which a region aside from the transmissive electrode in the pixel electrode in each second pixel is a reflective electrode.

According to the above configuration, a part of the pixel electrode of each of the first pixel and the second pixel is a transmissive electrode. In other words, both the first pixel and the second pixel are provided with a transflective electrode as the pixel electrode. With this configuration, even in a case in which both the first display region and the second display region conduct display using the transflective method, the direction of chromaticity change can be made the same for both display regions.

The liquid crystal display device according to the present invention is one in which the pixel electrode in each second pixel is the transmissive electrode.

The liquid crystal display device according to the present invention is one in which a region aside from the transmissive electrode in the pixel electrode in each first pixel is a reflective electrode that reflects light.

According to the above-mentioned configuration, the pixel electrode of the second pixel is a transmissive electrode. In other words, the first pixel is provided with a transflective electrode as a pixel electrode and the second pixel is provided with a transmissive electrode as a pixel electrode. Therefore, even if the first display region conducts display using the transflective method and the second display region conducts display using the transmissive method, the direction of chromaticity change can be made the same for both display regions.

The specific embodiments and examples provided in the detailed description of the present invention section are merely for illustration of the technical contents of the present invention. The present invention shall not be narrowly interpreted by being limited to such specific examples. Various changes can be made within the spirit of the present invention and the scope as defined by the appended claims.

### INDUSTRIAL APPLICABILITY

The liquid crystal display device of the present invention can be suitably used for a display screen of electronic devices such as personal computers, mobile telephones, personal digital assistants, portable music players, or digital cameras.

### DESCRIPTION OF REFERENCE CHARACTERS

1a, 1b pixel electrode

2 signal line

3 scanning line

4 thin film transistor

5 opposite electrode

6 liquid crystal cell

7a, 7b signal line driver circuit

8a, 8b scanning line driver circuit

9a, 9b opposite electrode driver circuit

10a, 10b pixel

11a, 11b, 21a, 21b display region

12 liquid crystal panel

14 memory circuit

15 transflective electrode

15a transmissive electrode

15b reflective electrode

16 transmissive electrode

20, 20a, 40 liquid crystal display device

1. A liquid crystal display device of a vertical alignment type having a plurality of pixels, comprising:
a pixel electrode, an opposite electrode facing the pixel electrode, and a liquid crystal layer interposed between the pixel electrode and the opposite electrode, for each pixel;
a first display region including a plurality of first pixels; and
a second display region including a plurality of second pixels differing from the plurality of first pixels,
wherein a part of the pixel electrode in each first pixel is a rectangular transmissive electrode that transmits light,
wherein at least a part of the pixel electrode in each second pixel is a rectangular transmissive electrode that transmits light, and
wherein an extension direction of a long side of the transmissive electrode of the first pixel and an extension direction of the long side of the transmissive electrode of the second pixel are the same.

2. The liquid crystal display device according to claim 1, wherein a part of the pixel electrode in each second pixel is the transmissive electrode.

3. The liquid crystal display device according to claim 1, wherein the pixel electrode in each second pixel is the transmissive electrode.

4. The liquid crystal display device according to claim 2, wherein a region aside from the transmissive electrode in the pixel electrode in each first pixel is a reflective electrode that reflects light, and
wherein a region aside from the transmissive electrode in the pixel electrode in each second pixel is a reflective electrode that reflects light.

5. The liquid crystal display device according to claim 3, wherein a region aside from the transmissive electrode in the pixel electrode in each first pixel is a reflective electrode that reflects light.
